(19) United States
(12) Patent Application Publication
(10) Pub. No.: US 2015/0015179 A1
(43) Pub. Date: Jan. 15, 2015

(54) CHARGE POWER CONTROL APPARATUS, CHARGE POWER CONTROL METHOD, PROGRAM, AND SOLAR POWER GENERATION SYSTEM

(71) Applicant: OMRON CORPORATION, KYOTO (JP)

(72) Inventors: Junichiro Yamada, Kyoto (JP); Wataru Okada, Kyoto (JP); Takeo Nishikawa, Kyoto (JP); Makoto Ohashi, Kyoto (JP); Yoshinori Sunahata, Shiga (JP)

(73) Assignee: OMRON CORPORATION, KYOTO (JP)

(21) Appl. No.: 14/378,111

(22) PCT Filed: Jan. 24, 2013
(86) PCT No.: PCT/JP2013/051380

§ 371 Date: Aug. 12, 2014

(30) Foreign Application Priority Data
Mar. 13, 2012 (JP) 2012-055627

(51) Int. Cl. H02J 7/00; H02J 7/35

(52) U.S. Cl. CPC H02J 7/007; H02J 7/35; H02J 7/0052; H02J 2007/0059
USPC 320/101; 320/162

(57) ABSTRACT

The present disclosure relates to a charge power control apparatus, a charge power control method, a program, and a solar power generation system, for improving charge efficiency. A solar power generation system includes a solar panel that receives sunlight to generate power, a PV power conditioner that performs DC/AC conversion of the power generated by the solar panel, and a charging AC/DC converter that performs AC/DC conversion of power output from the PV power conditioner and charges a storage battery. Voltage of the power supplied to the PV power conditioner from the solar panel is acquired while the power supplied from a power system is stopped, and a change in power supplied to the PV power conditioner from the solar panel is obtained according to the voltage. Charge power that is output from the charging AC/DC converter to charge the storage battery is adjusted based on the change in voltage.

### TECHNICAL FIELD

The present disclosure relates to a charge power control apparatus, a charge power control method, a program, and a solar power generation system, particularly to a charge power control apparatus, a charge power control method, a program, and a solar power generation system, for being able to improve charge efficiency.

### BACKGROUND ART

Nowadays, a solar power generation system including a solar power generation panel and a storage battery is in widespread use. In the solar power generation system, after power generated by the solar power generation panel is subjected to DC/AC (Direct Current/Alternating Current) conversion by a solar panel power conditioner, the power is supplied to and consumed by a load, or the power is returned to a power system for the purpose of power selling. The power supplied from the power system or the power generated by the solar power generation panel is subjected to AC/DC conversion by a charging AC/DC (Alternating Current/Direct Current) converter and stored in the storage battery, which allows the power to be used in night-time or power outage.

Conventionally, in a configuration of the solar power generation system, when the power outage is generated, a power path is switched to charge the storage battery such that the power output from a self-sustained output terminal of the solar panel power conditioner is supplied to the charging AC/DC converter.

For example, Patent Documents 1 and 2 propose a system in which, when the power outage is generated, a power supply path is switched such that connection of the solar power generation panel to the power system is separated to supply the power generated by the solar power generation panel to the storage battery.

The charging AC/DC converter adjusts charge power, which is output to charge the storage battery, based on the power stored in the storage battery or the temperature of the storage battery. On the other hand, output power output from the solar panel power conditioner changes according to the power generated by the solar power generation panel.

Therefore, when the power outage is generated to store the power output from the solar panel power conditioner in the storage battery via the charging AC/DC converter, sometimes the charge power output from the charging AC/DC converter exceeds the output power output from the solar panel power conditioner. When the charge power output from the charging AC/DC converter exceeds the output power output from the solar panel power conditioner, the output of the solar panel power conditioner decreases rapidly, and sometimes the solar panel power conditioner is stopped.

For example, FIG. 1 illustrates examples of measurement results of input power and output power when the solar panel power conditioner is stopped. In FIG. 1, a vertical axis indicates the power and a horizontal axis indicates a clock time. In FIG. 1, at clock times indicated by outline arrows, the output power of the solar panel power conditioner decreases rapidly to stop the solar panel power conditioner.

As illustrated in FIG. 1, when the charging AC/DC converter excessively demands the power output from the solar panel power conditioner, the solar panel power conditioner is stopped because the solar panel power conditioner cannot output the demanded power. Therefore, because the demand for the power from the charging AC/DC converter is stopped, the solar panel power conditioner operates again to resume the output of the power. However, when similarly the charging AC/DC converter excessively demands the power, the solar panel power conditioner is stopped again. The operation and the stopping of the solar panel power conditioner are repeated.

In FIG. 1, due to conversion efficiency of the solar panel power conditioner, the output power output from the solar panel power conditioner is lower than the input power input to the solar panel power conditioner.

### PRIOR ART DOCUMENTS

### Patent Documents

Patent Document 1: Japanese Unexamined Patent Publication No. 2007-124811
Patent Document 2: Japanese Unexamined Patent Publication No. 11-225448

### SUMMARY OF THE INVENTION

### Problem to be Solved by the Invention

As described above, in the conventional solar power generation system, due to the repetitions of the operation and the stopping of the solar panel power conditioner, not only the storage battery cannot stably be charged, but also the charge efficiency degrades.

In view of the above, an object of the disclosure is to be able to improve the charge efficiency.

### Means for Solving the Problem

In accordance with one aspect of the disclosure, a charge power control apparatus includes: an acquisition unit configured to acquire data related to current or voltage supplied to a converter from a power generator while power supplied from a power system is stopped, the power generator being configured to generate power using natural energy, the converter being configured to perform DC/AC conversion of power generated by the power generator; an arithmetic unit configured to calculate a change in the current or voltage supplied to the converter from the power generator according to the data acquired by the acquisition unit; and an adjustment unit configured to adjust charge power that is output from a charge unit to charge a storage battery based on a calculation result of the arithmetic unit, the charge unit being configured to perform AC/DC conversion of output power output from the converter and to charge the storage battery.

In accordance with another aspect of the disclosure, a charge power control method or a program includes the steps of: acquiring data related to current or voltage supplied to a converter from a power generator while power supplied from a power system is stopped, the power generator being configured to generate power using natural energy, the converter being configured to perform DC/AC conversion of power generated by the power generator; calculating a change in the current or voltage supplied to the converter from the power generator according to the acquired data; and adjusting charge power that is output from a charge unit to charge a storage battery based on a calculation result, the charge unit being configured to perform AC/DC conversion of output power output from the converter and to charge the storage battery.

In accordance with still another aspect of the disclosure, a solar power generation system includes: a solar panel configured to receive sunlight to generate power; a converter configured to perform DC/AC of power generated by the solar panel; a charge unit configured to perform AC/DC conversion of output power output from the converter and to charge a storage battery; an acquisition unit configured to acquire data related to current or voltage supplied to the converter from the solar panel while power supplied from a power system is stopped; an arithmetic unit configured to calculate a change in the current or voltage supplied to the converter from the solar panel according to the data acquired by the acquisition unit; and an adjustment unit configured to adjust charge power that is output from the charge unit to charge the storage battery based on a calculation result of the arithmetic unit.

In the aspects of the disclosure, the data related to the current or voltage supplied to the converter from the power generator or the solar panel is acquired while the power supplied from the power system is stopped, and the change in the current or voltage supplied to the converter from the power generator or the solar panel is calculated according to the acquired data. The charge power that is output from the charge unit to charge the storage battery is adjusted based on the calculation result.

### Effect of the Invention

According to one aspect of the disclosure, the charge efficiency can be improved.

### BRIEF DESCRIPTION OF THE DRAWINGS

FIG. 1 is a diagram illustrating stopping of a conventional solar panel power conditioner.

FIG. 2 is a block diagram illustrating a configuration example of a solar power generation system according to a first embodiment to which the technology of the disclosure is applied.

FIG. 3 is a diagram illustrating changes in input voltage, input current, and output current of a PV power conditioner.

FIG. 4 is a block diagram illustrating a configuration example of a charge power control apparatus.

FIG. 5 is a flowchart illustrating a first charge power control method in the solar power generation system.

FIG. 6 is a flowchart illustrating a second charge power control method in the solar power generation system.

FIG. 7 is a diagram illustrating the changes in input voltage and input current of the PV power conditioner in the second charge power control method.

FIG. 8 is a block diagram illustrating a configuration example of a solar power generation system according to a second embodiment to which the technology of the disclosure is applied.

### MODE FOR CARRYING OUT THE INVENTION

Specific embodiments to which the technology of the disclosure is applied will be described below with reference to the drawings.

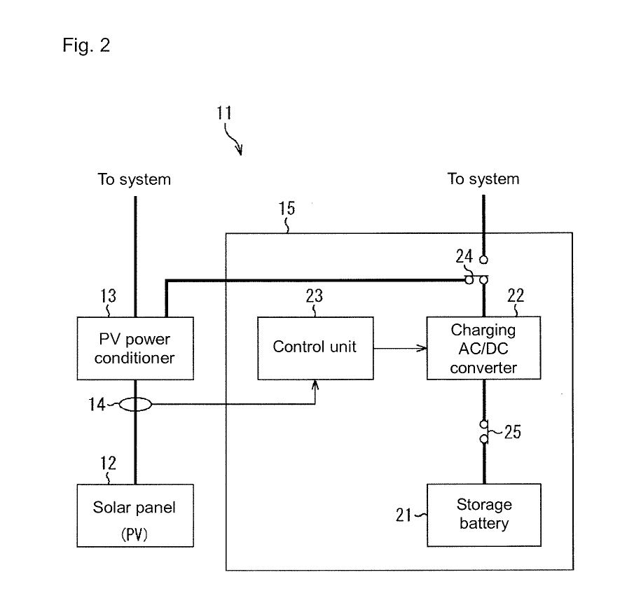

FIG. 2 is a block diagram illustrating a configuration example of a solar power generation system according to a first embodiment to which the technology of the disclosure is applied.

Referring to FIG. 2, solar power generation system 11 includes solar panel (PV (photovoltaic)) 12, PV power conditioner 13, measuring instrument 14, and electricity storage device 15.

Solar panel 12 is one that is configured to connect a plurality of solar cell modules to one another, and solar panel 12 receives sunlight to generate power.

For example, PV power conditioner 13 adjusts a voltage and a current of the power generated by solar panel 12 such that the maximum power can be acquired from solar panel 12. PV power conditioner 13 performs DC/AC conversion of the power generated by solar panel 12, and outputs the converted power to a power system (not illustrated). For example, PV power conditioner 13 includes a self-sustained output terminal that outputs the power when power outage is generated, and the self-sustained output terminal is connected to electricity storage device 15.

Measuring instrument 14 is provided on a wiring through which the power generated by solar panel 12 is transmitted to PV power conditioner 13. Measuring instrument 14 measures an input voltage and an input current of the power input from solar panel 12 to PV power conditioner 13.

Electricity storage device 15 includes storage battery 21, charging AC/DC converter 22, and control unit 23, and relays 24 and 25 are connected to the wiring in electricity storage device 15.

Charging AC/DC converter 22 performs AC/DC conversion of the power supplied from the power system or the power supplied from the self-sustained output terminal of PV power conditioner 13, and charges storage battery 21. A terminal on an AC side of charging AC/DC converter 22 is connected to one of the power system and the self-sustained output terminal of PV power conditioner 13 via relay 24. For example, when the power outage is generated, as illustrated in FIG. 2, relay 24 connects charging AC/DC converter 22 and PV power conditioner 13, and charging AC/DC converter 22 performs the AC/DC conversion of the power from PV power conditioner 13 to charge storage battery 21.

Storage battery 21 is connected to a DC side terminal of charging AC/DC converter 22 via relay 25, and stores the power supplied from charging AC/DC converter 22.

For example, control unit 23 includes a CPU (Central Processing Unit), a memory, and an input/output interface. The CPU executes a program stored in the memory to control each unit of electricity storage device 15 via the input/output interface. For example, control unit 23 reads the input voltage and input current measured by measuring instrument 14, and controls charging AC/DC converter 22 to increase or decrease charge power to output to charge storage battery 21.

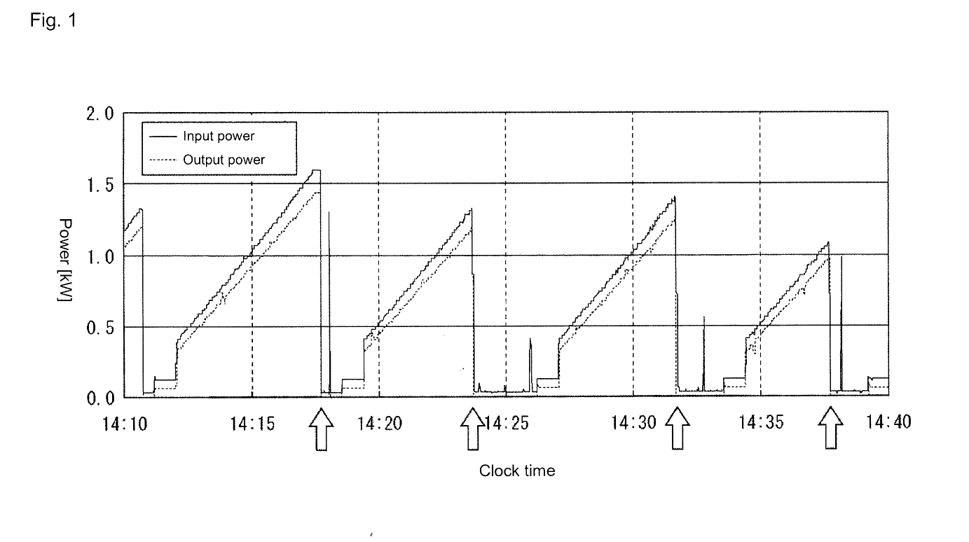

For example, as described above with reference to FIG. 1, when the charge power output from charging AC/DC converter 22 exceeds the output power of PV power conditioner 13, the output power of PV power conditioner 13 decreases rapidly and sometimes operation of PV power conditioner 13 is stopped. The applicant focuses on a tendency of the input voltage of the power input to PV power conditioner 13 to decrease before the rapid change in output current output from PV power conditioner 13.

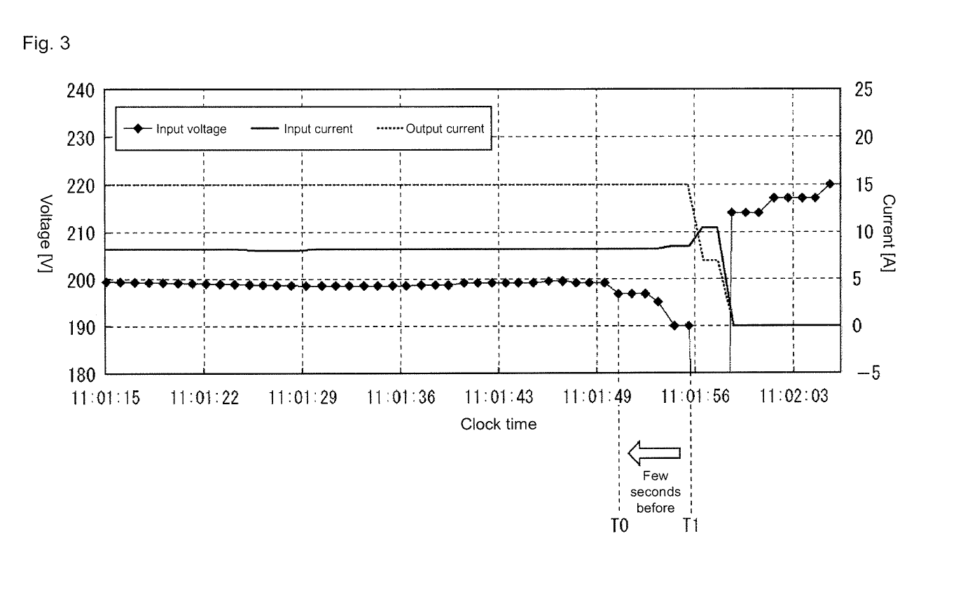

FIG. 3 illustrates examples of the changes in input voltage, input current, and output current of PV power conditioner 13. In FIG. 3, a vertical axis on the left side indicates a voltage, a vertical axis on the right side indicates a current, and a horizontal axis indicates a clock time in a time zone for which the rapid decrease in output current is detected.

As illustrated in FIG. 3, the output current decreases rapidly at clock time T1, and it is indicated that the operation of PV power conditioner 13 is stopped at clock time T1. The input voltage tends to decrease from clock time T0 a few seconds before clock time T1.

Accordingly, when detecting the decrease in input voltage of PV power conditioner 13 measured by measuring instrument 14, control unit 23 controls charging AC/DC converter 22 such that the charge voltage decreases. Therefore, the charge power output from charging AC/DC converter 22 does not exceed the output power of PV power conditioner 13, but the stopping of the operation of PV power conditioner 13 can be avoided.

In FIG. 3, although the change in input current is expressed small because of the setting of the right-side vertical axis indicating the current, the input current also tends to increase from a few seconds before the rapid decrease in output current similarly to the input voltage. Although charge power control processing of avoiding stopping the operation of PV power conditioner 13 based on fluctuation in input voltage will be described below, the similar charge power control processing can be performed based on fluctuation in input current.

In solar power generation system 11, a program used to perform the charge power control processing of avoiding stopping the operation of PV power conditioner 13 is stored in the memory of control unit 23, and the CPU of control unit 23 executes the program to implement the function as the charge power control apparatus.

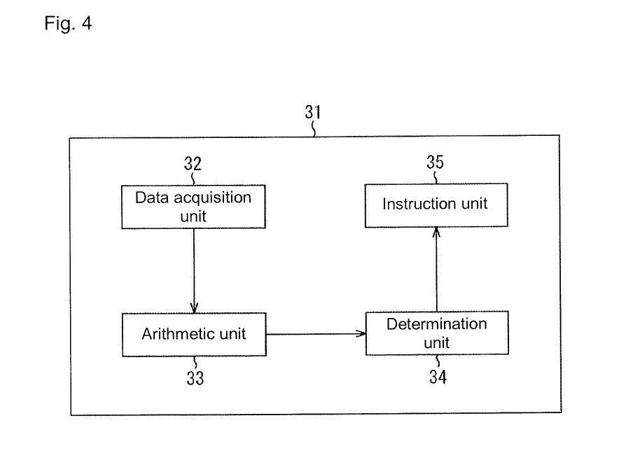

FIG. 4 is a functional block diagram illustrating control unit 23 that acts as the charge power control apparatus.

As illustrated in FIG. 4, charge power control apparatus 31 includes data acquisition unit 32, arithmetic unit 33, determination unit 34, and instruction unit 35.

Data acquisition unit 32 acquires data (for example, a current value or a voltage value) related to the power input to PV power conditioner 13 from solar panel 12, and supplies the data to arithmetic unit 33. For example, data acquisition unit 32 performs sampling at predetermined sampling intervals to acquire the input voltage of PV power conditioner 13 measured by measuring instrument 14.

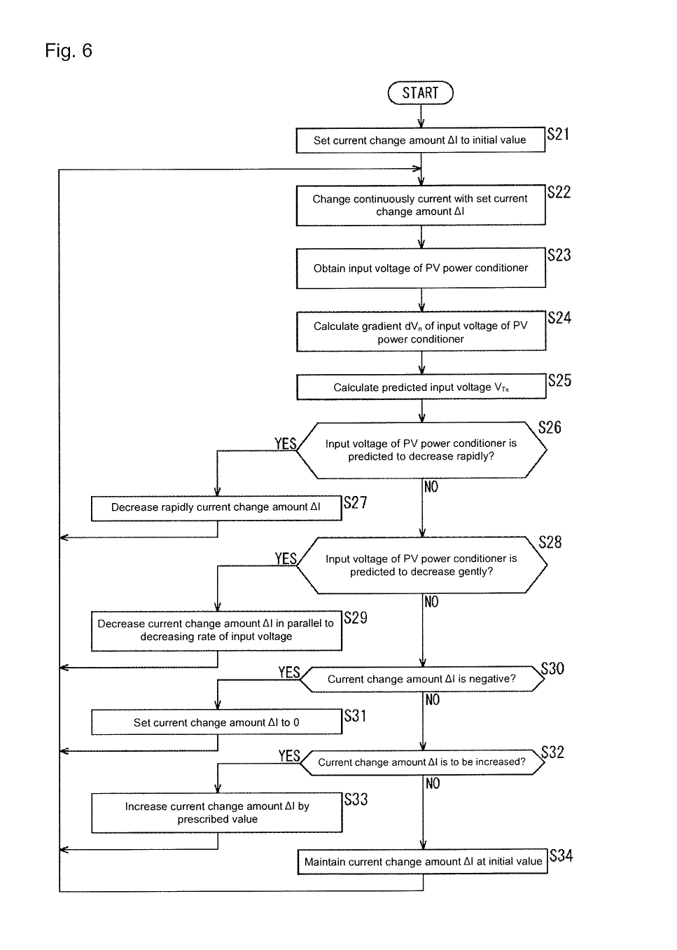

Arithmetic unit 33 calculates voltage change amount ΔV of the input voltage of PV power conditioner 13 based on the input voltage acquired by data acquisition unit 32. Alternatively, as described later with reference to a flowchart in FIG. 6, arithmetic unit 33 calculates predicted input voltage V_{Tx} based on the input voltage acquired by data acquisition unit 32.

Based on a calculation result of arithmetic unit 33, for example, determination unit 34 determines an increase or decrease in charge power P output from charging AC/DC converter 22, and notifies instruction unit 35 of a determination result.

Based on the determination result of determination unit 34, instruction unit 35 issues an instruction to charging AC/DC converter 22 to increase or decrease charge power P that is output to charge storage battery 21, thereby adjusting charge power P. As described later with reference to a flowchart in FIG. 6, instruction unit 35 issues an adjustment instruction to adjust current change amount ΔI of the input current input to charging AC/DC converter 22 from PV power conditioner 13 based on the determination result of determination unit 34.

For example, in charge power control apparatus 31, determination unit 34 makes the determination such that charge power P output from charging AC/DC converter 22 decreases when an absolute value of voltage change amount ΔV of the input voltage of PV power conditioner 13 changes by a certain value or more. According to the determination result, instruction unit 35 issues the instruction to charging AC/DC converter 22 to decrease charge power P, thereby adjusting charge power P.

Therefore, because the charge power output from charging AC/DC converter 22 can avoid exceeding the output power of PV power conditioner 13, the stopping of the operation of PV power conditioner 13 is avoided.

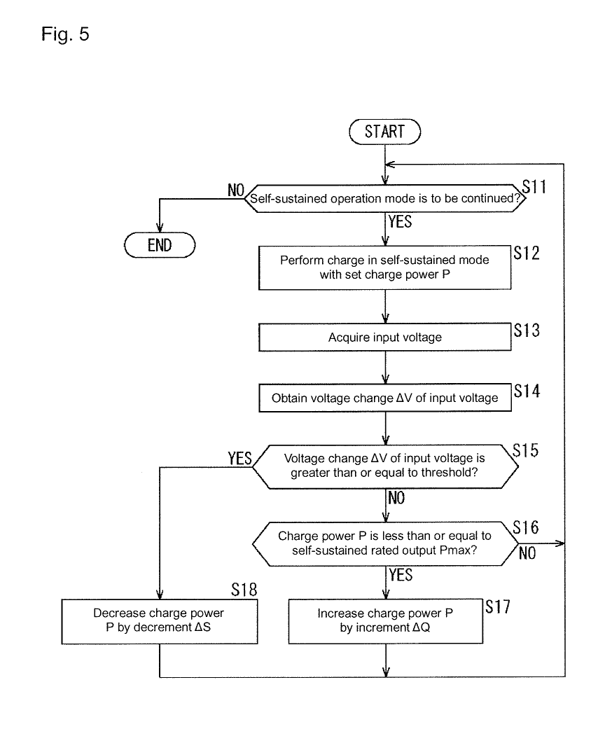

A first charge power control method in solar power generation system 11 will be described below with reference to a flowchart in FIG. 5.

For example, when the power outage is generated to stop the power supplied from the power system, a self-sustained operation mode is started in solar power generation system 11 such that storage battery 21 of electricity storage device 15 is charged with the power output from a self-sustained output terminal of PV power conditioner 13.

In Step S11, PV power conditioner 13 and electricity storage device 15 determine whether the self-sustained operation mode is to be continued. For example, when recovery of the power supplied from the power system is detected, PV power conditioner 13 and electricity storage device 15 determine that the self-sustained operation mode is not to be continued, and the processing is ended.

On the other hand, when the power supplied from the power system remains stopped, PV power conditioner 13 and electricity storage device 15 determine that the self-sustained operation mode is to be continued, and the processing goes to Step S12.

In Step S12, charging AC/DC converter 22 performs the AC/DC conversion of the power output from the self-sustained output terminal of PV power conditioner 13, and performs the output at set charge power P to charge storage battery 21 in the self-sustained mode. For example, at the beginning of the processing, charging AC/DC converter 22 charges storage battery 21 by setting charge power P according to a state of charge of storage battery 21. As described later, in the case that charge power P is adjusted so as to increase or decrease in Step S17 or S18, charging AC/DC converter 22 charges storage battery 21 using adjusted charge power P.

In Step S13, data acquisition unit 32 (see FIG. 4) acquires input voltage Vₙ at a present clock time by sampling the input voltage of PV power conditioner 13 measured by measuring instrument 14, and supplies input voltage Vₙ to arithmetic unit 33.

In Step S14, every time input voltage Vₙ at the present clock time is supplied from data acquisition unit 32, arithmetic unit 33 calculates a difference between input voltage Vₙ at the present clock and input voltage Vₙ₋₁ at a preceding clock time, namely, voltage change amount ΔV (=Vₙ−Vₙ₋₁) of input voltage Vₙ of PV power conditioner 13, and supplies voltage change amount ΔV to determination unit 34.

In Step S15, determination unit 34 determines whether the absolute value of voltage change amount ΔV of the input voltage obtained by arithmetic unit 33 is greater than or equal to a previously-set threshold (the certain value). At this point, for example, the threshold is set according to an error level of the measurement performed by measuring instrument 14.

When determination unit 34 determines that the absolute value of voltage change amount ΔV of the input voltage is less than the threshold in Step S15, the processing goes to Step S16.

In Step S16, determination unit 34 determines whether charge power P of charging AC/DC converter 22 is less than or equal to self-sustained rated output Pmax (for example, 1.5 kW) of PV power conditioner 13.

When determination unit 34 determines that charge power P of charging AC/DC converter 22 is less than or equal to self-sustained rated output Pmax of PV power conditioner 13 in Step S16, the processing goes to Step S17.

In Step S17, determination unit 34 notifies instruction unit 35 of the determination result indicating that charge power P output from charging AC/DC converter 22 is to be increased. In response to the notification, instruction unit 35 issues the adjustment instruction to charging AC/DC converter 22 to increase charge power P by previously-set increment ΔQ (P=P+ΔQ).

In this case, the absolute value of voltage change amount ΔV is less than the threshold, the input voltage is stabilized, and charge power P of charging AC/DC converter 22 is less than or equal to self-sustained rated output Pmax of PV power conditioner 13, so that PV power conditioner 13 can stably output the power even if the output power is increased. Accordingly, in response to the instruction from determination unit 34, charging AC/DC converter 22 charges storage battery 21 using charge power P that is increased by increment ΔQ.

Then, the processing returns to Step S11, and the similar processing is repeated.

On the other hand, when determination unit 34 determines that charge power P of charging AC/DC converter 22 is greater than self-sustained rated output Pmax of PV power conditioner 13 in Step S16, the processing returns to Step S11, and the similar processing is repeated. In this case, because PV power conditioner 13 cannot output the power larger than self-sustained rated output Pmax although PV power conditioner 13 stably outputs the power, determination unit 34 determines that charge power P output from charging AC/DC converter 22 is to be maintained.

On the other hand, when determination unit 34 determines that the absolute value of voltage change amount ΔV of the input voltage is greater than or equal to the threshold in Step S15, the processing goes to Step S18.

In Step S18, determination unit 34 notifies instruction unit 35 of the determination result indicating that charge power P output from charging AC/DC converter 22 is to be decreased. In response to the notification, instruction unit 35 issues the adjustment instruction to charging AC/DC converter 22 to decrease charge power P by previously-set decrement ΔS (P=P−ΔS).

That is, the absolute value of voltage change amount ΔV of the input voltage is greater than or equal to the threshold, so that the determination that the input voltage of PV power conditioner 13 starts to decrease can be made. Accordingly, in response to the instruction from determination unit 34, charging AC/DC converter 22 charges storage battery 21 using charge power P that is decreased by decrement ΔS. Then, the processing returns to Step S11, and the similar processing is repeated.

As described above, in solar power generation system 11, in the case that the determination that the input voltage of PV power conditioner 13 starts to decrease is made, the charge power output from charging AC/DC converter 22 can be adjusted so as to decrease. Therefore, the charge power output from charging AC/DC converter 22 can avoid exceeding the output power of PV power conditioner 13, and the stopping of the operation of PV power conditioner 13 can be avoided.

Accordingly, in solar power generation system 11, the operation and the stopping of the solar panel power conditioner is not repeated unlike the conventional technology described above with reference to FIG. 1. Therefore, storage battery 21 can stably be charged, and the degradation of the charge efficiency can be avoided.

For example, as to increment ΔQ and decrement ΔS used to adjust charge power P, fixed values may be set, or a function of voltage change amount ΔV of the input voltage may be set. For example, the decrease in input voltage of PV power conditioner 13 can more quickly be recovered using the function that increases increment ΔQ and decrement ΔS for large voltage change amount ΔV of the input voltage and decreases increment ΔQ and decrement ΔS for small voltage change amount ΔV of the input voltage.

A second charge power control method in solar power generation system 11 will be described below with reference to the flowchart in FIG. 6.

For example, when the power outage is generated to stop the power supplied from the power system, a self-sustained operation mode is started in solar power generation system 11 such that storage battery 21 of electricity storage device 15 is charged with the power output from a self-sustained output terminal of PV power conditioner 13.

In Step S21, instruction unit 35 issues an instruction to charging AC/DC converter 22 to set initial current change amount Is set as an initial value to current change amount ΔI that is of a change amount (change rate) per unit time of the current on the input side of charging AC/DC converter 22 (ΔI=Is (mA/s)).

In Step S22, while continuously changing the current with current change amount ΔI set in Step S21, charging AC/DC converter 22 takes out the power from the self-sustained output terminal of PV power conditioner 13 to perform the AC/DC conversion, and outputs the power as the charge power used to charge storage battery 21. The current that can be output from the self-sustained output terminal by PV power conditioner 13 is prescribed in a range of 0 to 15 A.

In Step S23, data acquisition unit 32 acquires input voltage Vₙ at present clock time tₙ by sampling the input voltage of PV power conditioner 13 measured by measuring instrument 14, and supplies input voltage Vₙ to arithmetic unit 33.

In Step S24, arithmetic unit 33 calculates gradient dVₙ of the input voltage from the change in input voltage of PV power conditioner 13. Input voltage V of PV power conditioner 13 is supplied to arithmetic unit 33 every time data acquisition unit 32 performs the sampling. For example, arithmetic unit 33 calculates gradient dVₙ (=(Vₙ−Vₙ₋₁)/(tₙ−tₙ₋₁)) of the input voltage by dividing a difference between input voltage Vₙ at present clock time tₒ and input voltage Vₙ₋₁ at preceding clock time tₙ₋₁ by time interval Δt (=tₙ−tₙ₋₁) of the sampling clock time.

In Step S25, arithmetic unit 33 calculates predicted input voltage V_{Tx}, and supplies predicted input voltage V_{Tx} to determination unit 34. Predicted input voltage VTₓ is a predicted input voltage of PV power conditioner 13 at clock time T_{X} (=Δt×X) at which sampling time interval X elapses while gradient dVₙ of the input voltage calculated in Step S24 is maintained. For example, arithmetic unit 33 obtains predicted input voltage V_{Tx} (=dVₙ×T_{X}+Vₙ) by adding input voltage Vₙ to a product of clock time T_{X} and gradient dVₙ of the input voltage.

In Step S26, based on predicted input voltage V_{Tx} calculated in Step S25 by arithmetic unit 33, determination unit 34 determines whether the input voltage of PV power conditioner 13 is predicted to decrease rapidly when sampling time interval X elapses while gradient dVₙ of the present input voltage is maintained. For example, first threshold A is set to determination unit 34 in order to determine the rapid change in input voltage. Determination unit 34 determines that the input voltage of PV power conditioner 13 is predicted to decrease rapidly in the case that predicted input voltage V_{Tx} is less than or equal to a ratio of first threshold A to input voltage Vₙ at present clock time tₙ (V_{Tx}≦Vₙ×A %).

When determination unit 34 determines that the input voltage of PV power conditioner 13 is predicted to decrease rapidly in Step S26, for example, when determination unit 34 determines that predicted input voltage V_{Tx} is less than or equal to A % of input voltage Vₙ, the processing goes to Step S27.

In Step S27, determination unit 34 notifies instruction unit 35 of the determination result indicating that the input voltage input to PV power conditioner 13 is predicted to decrease largely. In response to the notification, instruction unit 35 issues an adjustment instruction to charging AC/DC converter 22 to rapidly decrease current change amount ΔI in a quadratic-function manner according to a predicted decreasing rate of the input voltage. Specifically, instruction unit 35 obtains current change amount ΔI newly set to charging AC/DC converter 22 according to the following equation (1), and issues an instruction to charging AC/DC converter 22 to set obtained current change amount ΔI.

ΔI=Q×ΔI−(R×ΔVp²+S×ΔVp+T)×Ia (1)

In the equation (1), Q, R, S, and T are predetermined constants, Ia is a predetermined current change amount, and ΔVp is a decreasing rate of the input voltage obtained by (Vₙ−V_{Tx})/Vₙ.

After the processing in Step S27, the processing returns to Step S22. In Step S22, while changing the current with current change amount ΔI newly set in Step S27, charging AC/DC converter 22 takes out the power from the self-sustained output terminal of PV power conditioner 13 to charge storage battery 21. Then the similar processing is repeated. In this case, the determination that PV power conditioner 13 cannot supply the power is made, and the adjustment for the rapid decrease is performed according to the predicted decreasing rate of the input voltage when the input current of charging AC/DC converter 22 is to be decreased.

On the other hand, when determination unit 34 determines that the input voltage of PV power conditioner 13 is not predicted to decrease rapidly in Step S26, for example, when determination unit 34 determines that predicted input voltage V_{Tx} is greater than A % of input voltage Vₙ, the processing goes to Step S28.

In Step S28, based on predicted input voltage V_{Tx} calculated in Step S25 by arithmetic unit 33, determination unit 34 determines whether the input voltage of PV power conditioner 13 is predicted to decrease gently when sampling time interval X elapses while gradient dVₙ of the present input voltage is maintained. For example, second threshold B (threshold B>threshold A) is set to determination unit 34 in order to determine the rapid change in input voltage. Determination unit 34 determines that the input voltage of PV power conditioner 13 is predicted to decrease gently in the case that predicted input voltage V_{Tx} is less than or equal to a ratio of second threshold B to input voltage Vₙ at present clock time tₙ (V_{Tx}≦Vₙ×B %).

When determination unit 34 determines that the input voltage of PV power conditioner 13 is predicted to decrease gently in Step S28, for example, when determination unit 34 determines that predicted input voltage V_{Tx} is less than or equal to B % of input voltage Vₙ, the processing goes to Step S29.

In Step S29, determination unit 34 notifies instruction unit 35 of the determination result indicating that the input voltage of PV power conditioner 13 is predicted to decrease gently. In response to the notification, instruction unit 35 issues the adjustment instruction to charging AC/DC converter 22 to decrease current change amount ΔI in a linear-function manner according to (in parallel to) the predicted decreasing rate of the input voltage. Specifically, instruction unit 35 obtains current change amount ΔI newly set to charging AC/DC converter 22 according to the following equation (2), and issues the instruction to charging AC/DC converter 22 to set obtained current change amount ΔI.

ΔI=ΔI−(U×ΔVp+V)×Ib (2)

In the equation (2), U and V are predetermined constants, Ib is a predetermined current change amount, and ΔVp is the decreasing rate of the input voltage obtained by (Vₙ−V_{Tx})/Vₙ.

After the processing in Step S29, the processing returns to Step S22. In Step S22, while changing the current with current change amount ΔI newly set in Step S29, charging AC/DC converter 22 takes out the power from the self-sustained output terminal of PV power conditioner 13 to charge storage battery 21. Then the similar processing is repeated. In this case, the adjustment for the slight decrease of current change amount ΔI is performed in order to prevent the gentle decrease in input voltage of PV power conditioner 13.

On the other hand, when determination unit 34 determines that the input voltage of PV power conditioner 13 is not predicted to decrease gently in Step S28, for example, when determination unit 34 determines that predicted input voltage V_{Tx} is greater than B % of input voltage Vₙ, the processing goes to Step S30.

In Step S30, determination unit 34 determines whether present current change amount ΔI is negative (ΔI<0). When determination unit 34 determines that present current change amount ΔI is negative, the processing goes to Step S31.

In Step S31, determination unit 34 notifies instruction unit 35 of the determination result indicating that current change amount ΔI of the input voltage input to PV power conditioner 13 is negative. In response to the notification, instruction unit 35 issues an instruction to charging AC/DC converter 22 to set current change amount ΔI to 0 (ΔI=0).

For example, sometimes current change amount ΔI becomes negative by decreasing current change amount ΔI in Step S27 or S29. When determination unit 34 determines that the input voltage of PV power conditioner 13 is not predicted to decrease rapidly in Step S26, and when determination unit 34 determines that the input voltage of PV power conditioner 13 is not predicted to decrease gently in Step S28, namely, when the stopping of PV power conditioner 13 is avoided, the output power of PV power conditioner 13 decreases continuously when current change amount ΔI still remains negative. Therefore, in this case, the adjustment is performed to quickly recover current change amount ΔI to 0.

After the processing in Step S31, the processing returns to Step S22. In Step S22, charging AC/DC converter 22 charges storage battery 21 using the charge power corresponding to the power supplied with current change amount ΔI newly set in Step S31. Then the similar processing is repeated.

On the other hand, when determination unit 34 determines that present current change amount ΔI is not negative in Step S30, the processing goes to Step S32.

In Step S32, determination unit 34 determines whether current change amount ΔI is to be increased. For example, in the case that present current change amount ΔI is less than or equal to a value in which prescribed current change amount Ic is subtracted from initial current change amount Is set as the initial value (ΔI≦Is−Ic), determination unit 34 determines that current change amount ΔI is to be increased.

When determination unit 34 determines that current change amount ΔI is to be increased in Step S32, the processing goes to Step S33, and determination unit 34 notifies instruction unit 35 of the determination result indicating that current change amount ΔI is to be increased. In response to the notification, instruction unit 35 issues an adjustment instruction to charging AC/DC converter 22 to increase current change amount ΔI by adding prescribed current change amount Ic to current change amount ΔI.

After the processing in Step S33, the processing returns to Step S22. In Step S22, while changing the current with current change amount ΔI newly set in Step S33, charging AC/DC converter 22 takes out the power from the self-sustained output terminal of PV power conditioner 13 to charge storage battery 21. Then the similar processing is repeated. In this case, after the stopping of PV power conditioner 13 is avoided, the adjustment is performed to gradually increase current change amount ΔI.

On the other hand, when determination unit 34 determines that current change amount ΔI is not to be increased in Step S32, the processing goes to Step S34, and determination unit 34 notifies instruction unit 35 of the determination result indicating that current change amount ΔI is to be maintained at initial current change amount Is. In response to the notification, instruction unit 35 issues the instruction to charging AC/DC converter 22 to set initial current change amount Is set as the initial value to current change amount ΔI.

After the processing in Step S34, the processing returns to Step S22. In Step S22, while changing the current with current change amount ΔI (that is, initial current change amount Is) newly set in Step S34, charging AC/DC converter 22 takes out the power from the self-sustained output terminal of PV power conditioner 13 to charge storage battery 21. Then the similar processing is repeated. In this case, after the stopping of PV power conditioner 13 is avoided, the adjustment is performed such that the current is not increased with the change amount of initial current change amount Is or more.

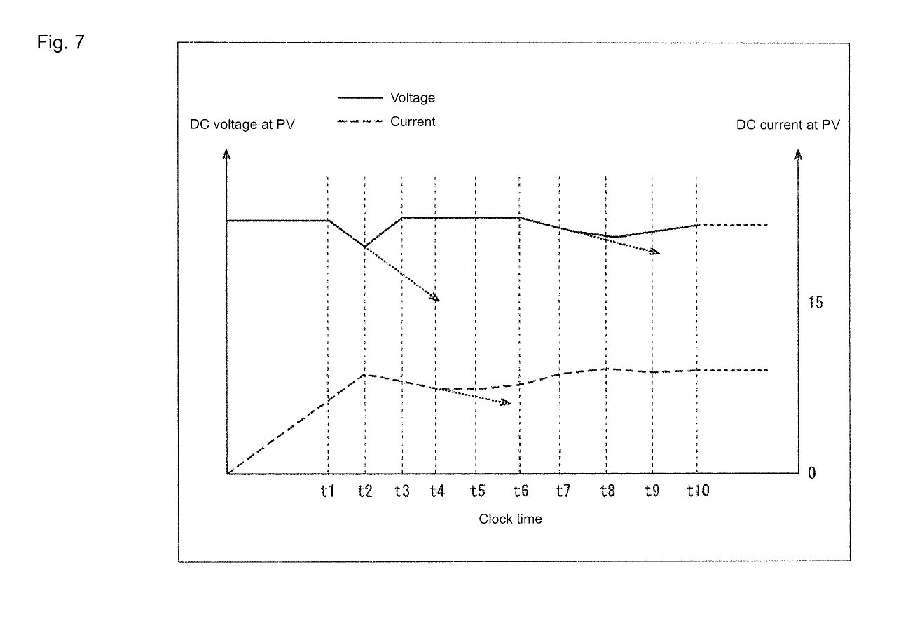

The changes in voltage and current of the power output from solar panel 12 by the second charge power control method in FIG. 6 will be described with reference to FIG. 7.

A vertical axis on the left side in FIG. 7 indicates a DC voltage of the power output from solar panel 12, a vertical axis on the right side in FIG. 7 indicates a DC current of the power output from solar panel 12, and a horizontal axis in FIG. 7 indicates a clock time.

For example, at the beginning of the output of the power from solar panel 12, the current increases with current change amount ΔI (that is, initial current change amount Is) set in Step S21 of FIG. 6, and the voltage is kept constant. In the case that the power generated by solar panel 12 at clock time t1 decreases, the voltage starts to decrease because the current increases continuously with current change amount ΔI.

When the determination that the voltage is predicted to decrease rapidly as indicated by a dotted line in FIG. 7 is made at clock time t2 (YES in Step S26), the processing is performed such that current change amount ΔI is rapidly decreased in the quadratic-function manner (Step S27). Therefore, the decrease in voltage is recovered at clock time t3. Then, current change amount ΔI is determined to be negative (YES in Step S30) at clock time t4, and current change amount ΔI is set to 0. Accordingly, the continuous decrease in current is avoided as indicated by a dotted line in FIG. 7.

Current change amount ΔI is increased with prescribed current change amount Ic at clock time 5 (Step S33), and current change amount ΔI is set to initial current change amount Is at clock time t6 (Step S34).

When the determination that the voltage is predicted to decrease gently as indicated by a dotted line in FIG. 7 is made at clock time t7 (YES in Step S28), the processing is performed such that current change amount ΔI is decreased in the linear-function manner (Step S29). Therefore, the voltage changes at clock time t8 such that the decrease in voltage is recovered. Then the similar processing is continued.

As described above, in solar power generation system 11, the processing is performed such that current change amount ΔI is rapidly decreased in the quadratic-function manner when the input voltage of PV power conditioner 13 is predicted to decrease rapidly, so that the decrease in input voltage of PV power conditioner 13 can quickly be recovered. Additionally, in solar power generation system 11, the processing is performed such that current change amount ΔI is decreased in the linear-function manner when the input voltage of PV power conditioner 13 is predicted to decrease gently, so that the decrease in input voltage of PV power conditioner 13 can gradually be recovered.

Thus, in solar power generation system 11, current change amount ΔI is properly adjusted according to the change in input voltage of PV power conditioner 13, so that the change in input voltage of PV power conditioner 13 can be constrained to efficiently charge storage battery 21.

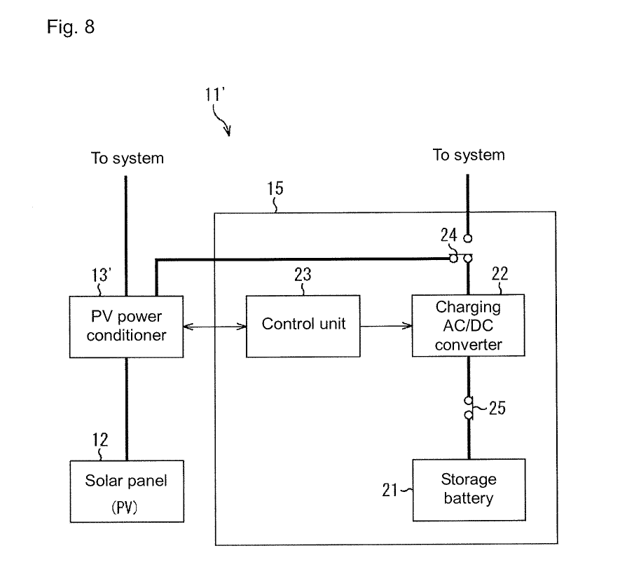

FIG. 8 is a block diagram illustrating a configuration example of a solar power generation system according to a second embodiment to which the technology of the disclosure is applied. In solar power generation system 11′ of FIG. 8, the same component as solar power generation system 11 in FIG. 2 is designated by the same symbol, and the detailed description is neglected.

As illustrated in FIG. 8, the configuration of solar power generation system 11′ is similar to that of solar power generation system 11 in FIG. 2 in that solar power generation system 11′ includes solar panel 12 and electricity storage device 15 and that electricity storage device 15 includes storage battery 21, charging AC/DC converter 22, and control unit 23. However, the configuration of solar power generation system 11′ differs from that of solar power generation system 11 in FIG. 2 in that solar power generation system 11′ does not include measuring instrument 14 and that solar power generation system 11′ includes PV power conditioner 13′ that can conduct communication with control unit 23 of electricity storage device 15.

That is, in solar power generation system 11′, PV power conditioner 13′ and control unit 23 of electricity storage device 15 conduct communication with each other, which allows control unit 23 to acquire the input voltage input to PV power conditioner 13′. Based on the input voltage acquired from PV power conditioner 13′, control unit 23 can perform the charge power control processing as described above.

The stopping of PV power conditioner 13′ can be avoided even in solar power generation system 11′ having the above configuration.

In the configurations of the embodiments, the power generated by solar panel 12 is stored in storage battery 21 by way of example. Instead of solar panel 12, a power generator which generates the power using natural energy may be used. For example, an electricity storage system in which the power generated by wind-power generation or biomass power generation is stored in storage battery 21 can be used. Data acquisition unit 32 may acquire the input current as the data related to the power input to PV power conditioner 13, and perform the charge power control processing.

The embodiment is not limited to the above embodiments, but various changes can be made without departing from the scope of the disclosure.

### DESCRIPTION OF SYMBOLS

11 solar power generation system
12 solar panel
13 PV power conditioner
14 measuring instrument
15 electricity storage device
21 storage battery
22 charging AC/DC converter
23 control unit
24, 25 relay
31 charge power control apparatus
32 data acquisition unit
33 arithmetic unit
34 determination unit
35 instruction unit

1. A charge power control apparatus comprising:
an acquisition unit configured to acquire data related to current or voltage supplied to a converter from a power generator while power supplied from a power system is stopped, the power generator being configured to generate power using natural energy, the converter being configured to perform DC/AC (Direct Current/Alternating Current) conversion of power generated by the power generator;
an arithmetic unit configured to calculate a change in the current or voltage supplied to the converter from the power generator according to the data acquired by the acquisition unit; and
an adjustment unit configured to adjust charge power that is output from a charge unit to charge a storage battery based on a calculation result of the arithmetic unit, the charge unit being configured to perform AC/DC conversion of output power output from the converter and to charge the storage battery.

2. The charge power control apparatus according to claim 1, wherein the adjustment unit adjusts the charge unit such that the charge power is decreased, when the calculation result of the arithmetic unit indicates that the current or voltage supplied to the converter from the power generator changes by a certain value or more.

3. The charge power control apparatus according to claim 1, wherein the arithmetic unit performs the calculation using the data acquired by the acquisition unit, and predicts the change in current or voltage input to the converter from the power generator at a clock time after a predetermined time from a present clock time, and
the adjustment unit decreases a change amount of input current input to the charge unit according to a predetermined first calculation when the arithmetic unit predicts that the current or voltage input to the converter from the power generator changes rapidly.

4. The charge power control apparatus according to claim 3, wherein the adjustment unit decreases the change amount of input current according to a second calculation when the arithmetic unit predicts that the current or voltage input to the converter from the power generator changes gently, the second calculation according to which the adjustment is performed more gently compared with the first calculation.

5. The charge power control apparatus according to claim 1, wherein the acquisition unit acquires the data by conducting communication with the converter.

6. A charge power control method comprising the steps of:
acquiring data related to current or voltage supplied to a converter from a power generator while power supplied from a power system is stopped, the power generator being configured to generate power using natural energy, the converter being configured to perform DC/AC (Direct Current/Alternating Current) conversion of power generated by the power generator;
calculating a change in the current or voltage supplied to the converter from the power generator according to the acquired data; and
adjusting charge power that is output from a charge unit to charge a storage battery based on a calculation result, the charge unit being configured to perform AC/DC conversion of output power output from the converter and to charge the storage battery.

7. A program configured to cause a computer to perform charge power control processing comprising the steps of:
acquiring data related to current or voltage supplied to a converter from a power generator while power supplied from a power system is stopped, the power generator being configured to generate power using natural energy, the converter being configured to perform DC/AC (Direct Current/Alternating Current) conversion of power generated by the power generator;
calculating a change in the current or voltage supplied to the converter from the power generator according to the acquired data; and
adjusting charge power that is output from a charge unit to charge a storage battery based on a calculation result, the charge unit being configured to perform AC/DC conversion of output power output from the converter and to charge the storage battery.

8. A solar power generation system comprising:
a solar panel configured to receive sunlight to generate power;
a converter configured to perform DC/AC (Direct Current/Alternating Current) of power generated by the solar panel;
a charge unit configured to perform AC/DC conversion of output power output from the converter and to charge a storage battery;
an acquisition unit configured to acquire data related to current or voltage supplied to the converter from the solar panel while power supplied from a power system is stopped;
an arithmetic unit configured to calculate a change in the current or voltage supplied to the converter from the solar panel according to the data acquired by the acquisition unit; and
an adjustment unit configured to adjust charge power that is output from the charge unit to charge the storage battery based on a calculation result of the arithmetic unit.
